(19) United States
(12) Patent Application Publication
(10) Pub. No.: US 2012/0078967 A1
(43) Pub. Date: Mar. 29, 2012

(54) Integration of a Framework Application and a Task Database

(75) Inventors: Heather J. Hagan, Charlotte, NC (US); Julie A. Knutson, Charlotte, NC (US); Karen Macauley, Drexel Hill, PA (US); James A. Blanchard, III, Midland, NC (US); Brian T. Kukwa, West Babylon, NY (US)

(73) Assignee: Bank of America Corporation, Charlotte, NC (US)

(21) Appl. No.: 12/890,118

(22) Filed: Sep. 24, 2010

(51) Int. Cl. G06F 17/30

(52) U.S. Cl. 707/792; 707/E17.045

(57) ABSTRACT

A financial services enterprise may provide for integrating a framework application and a task database. A flat file is extracted from a framework application, wherein the flat file is associated with a task and the task is associated with a financial services project. The flat file is manipulated to form a relational database data structure associated with the task. The relational database data structure is communicated to a management module, and the management module stores the relational database data structure in the task database to facilitate modeling the financial services project associated with a financial services enterprise.

### TECHNICAL FIELD OF THE INVENTION

This invention relates generally to integrating disparate components and, more specifically, to the integration of a framework application and a task database.

### BACKGROUND OF THE INVENTION

Enterprises use various business applications to perform operations within the enterprise. Within the enterprise, the business applications may utilize application-specific file formats and protocols. Therefore, the data used in the business applications cannot be correlated.

### SUMMARY OF THE INVENTION

In accordance with the present invention, disadvantages and problems associated with integrating information from a framework application and a task database may be reduced or eliminated.

According to one embodiment of the present invention, a financial services enterprise may provide for integrating a framework application and a task database. A flat file is extracted from a framework application, wherein the flat file is associated with a task and the task is associated with a financial services project. The flat file is manipulated to form a relational database data structure associated with the task. The relational database data structure is communicated to a management module, and the management module stores the relational database data structure in the task database to facilitate modeling the financial services project associated with a financial services enterprise.

Certain embodiments of the invention may provide one or more technical advantages. A technical advantage of one embodiment includes integrating a framework application and a task database through an automated method to consolidate tasks associated with the various financial services processes. This integration provides intelligent identification of specific tasks associated with a process, rather than having to manually determine the tasks associated with a process and subsequently manually applying the tasks to implement the process. Another technical advantage of the integration facilitates modeled processes to be reused across different business units within the enterprise, which reduces costs and improves efficiency.

Certain embodiments of the invention may include none, some, or all of the above technical advantages. One or more other technical advantages may be readily apparent to one skilled in the art from the figures, descriptions, and claims included herein.

### BRIEF DESCRIPTION OF THE DRAWINGS

For a more complete understanding of the present invention and its features and advantages, reference is now made to the following description, taken in conjunction with the accompanying drawings, in which:

FIG. 1 illustrates a system that facilitates integration of information from a framework application to a task database;

FIG. 2 illustrates a particular embodiment of the task database;

FIG. 3 illustrates an example screenshot illustrating the manipulation of flat files from the framework application; and

FIG. 4 illustrates a flowchart for integrating the information from the framework application to the task database.

### DETAILED DESCRIPTION OF THE INVENTION

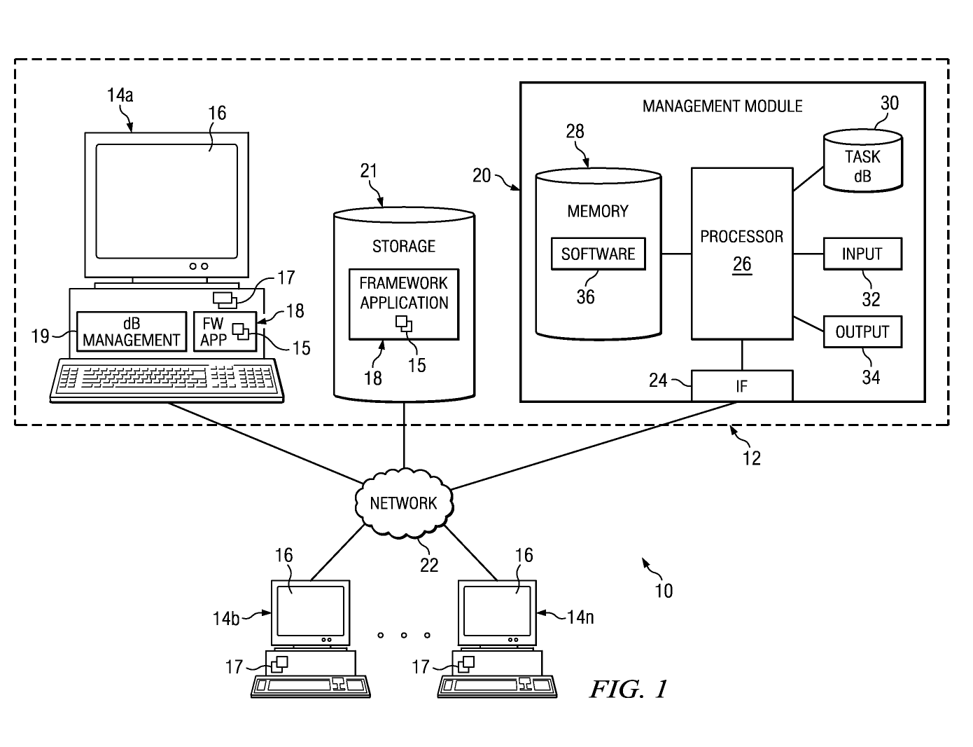

Embodiments of the present invention and its advantages are best understood by referring to FIGS. 1 through 4, like numerals being used for like and corresponding parts of the various drawings.

Enterprises typically include business units, divisions, or lines of business that handle various financial services projects within the enterprise. Financial service projects may include, but are not limited to, opening a deposit account, developing a financial services product, closing an account, originating a loan, managing risk portfolio, managing information technology infrastructure, or managing human resources. The business units may use different applications to handle the projects, even though the projects may use similar processes. Typically, the different applications that handle the various projects do not work in a coordinated manner, which increases operating costs and reduces efficiency. The teachings of the disclosure recognize that it would be desirable to integrate a framework application and a task database through an automated process to consolidate tasks associated with the various projects. This integration provides intelligent identification of specific tasks associated with a project and particular sequencing of the tasks to perform the project, rather than manually determining the tasks associated with a project and subsequently manually applying the tasks to implement the project. Additionally, this integration facilitates modeled processes to be reused across different business units within the enterprise, which reduces costs and improves efficiency.

FIG. 1 illustrates a system 10 that facilitates integration of information from a framework application 18 to a task database 30. System 10 may include an enterprise 12, one or more computers 14, a management module 20, and storage 21. Enterprise 12, computers 14, management module 20, and storage 21 may be communicatively coupled by a network 22. Computers 14 interact with management module 20 to facilitate integration of framework application 18 and task database 30.

System 10 includes an enterprise 12, which may refer to a financial institution, such as a bank, and may include computers 14 and management module 20. Even though enterprise 12 is referred to as a financial institution, enterprise 12 represents any suitable type of entity in any suitable industry. Enterprise 12 may have different business units that handle different business activities. For example, a retirement group, a call center, a wealth management group, an information technology group, a human resources group, a loan group, a banking group, a risk management group, and a global financial group represent different business units associated with enterprise 12. Computers 14 within enterprise 12, and the users of those computers 14, may each be associated with different business units. Because of the association with various business units, computers 14 may use different applications to handle the financial services projects. Management module 20 facilitates the integration of framework application 18 and task database 30 to implement the financial services projects.

Computers 14 communicate with management module 20 to implement activities associated with financial services projects. In another embodiment, computer 14a facilitates the integration of information between framework application 18 and task database 30, which allows computers 14b-14n to retrieve the information for use following the initial inclusion of the information into task database 30. In the illustrated embodiment, computer 14a may be used to create, revise, modify, or delete financial services projects used by enterprise 12. For example, a system architect, a business architect, or an administrator may use computer 14a. As illustrated, computer 14 may be within enterprise 12 or outside of enterprise 12. Computer 14 may include a personal computer, a workstation, a laptop, a wireless or cellular telephone, an electronic notebook, a personal digital assistant, or any other device (wireless, wireline, or otherwise) capable of receiving, processing, storing, and/or communicating information with other components of system 10. A user of computer 14 may initiate application 17 and manage application 17 based on the user's preferences. Computer 14 may also comprise a user interface, such as a display, a microphone, keypad, or other appropriate terminal equipment usable by a user.

In the illustrated embodiment, computer 14 includes a graphical user interface (“GUI”) 16 that displays information associated with applications 17 and information received from management module 20. GUI 16 is generally operable to tailor and filter data entered by and presented to the user. GUI 16 may provide the user with an efficient and user-friendly presentation of information using a plurality of displays having interactive fields, pull-down lists, and buttons operated by the user. GUI 16 may include multiple levels of abstraction including groupings and boundaries. It should be understood that the term GUI 16 may be used in the singular or in the plural to describe one or more GUIs 16 in each of the displays of a particular GUI 16.

Computer 14 also includes one or more applications 17. Application 17 represents any suitable software or logic that allows a user to analyze and/or process information for a customer or client. For example, application 17 may include a web application, a generic application, a routine application, a third-party application, a high-on-demand application, an application associated with a business unit, or any other future application types. According to an embodiment, applications 17 associated with different business units may be integrated using management module 20.

Framework application 18 represents any suitable software or logic that enables a user to structure and scope business architecture domains and financial services projects using accelerated modeling. The modeling may provide a starting point for users and/or business units to understand the requirements needed to update systems and processes within enterprise 12. Framework application 18 stores the requirements associated with a project and creates realistic financial services process and business process models to understand the current and proposed business architecture. For example, framework application 18 may group various business tasks according to the business concept. In an embodiment, framework application 18 is a proprietary IBM® Information Framework (IFW) application for enterprises 12. Framework application 18 facilitates the integration of product lines between business units, integrates communication channels to provide a consistent experience, rolls out new offerings while leveraging existing infrastructure, or effectively integrates disparate enterprises 12.

Framework application 18 includes flat files 15 that represent information to be stored in task database 30. In a particular embodiment, flat file 15 may include a proprietary M1 file associated with IBM's IFW. Flat file 15 may include a string of characters, such as numbers and/or letters, that provide particular information to a user. The characters within flat file 15 may be spaced in a particular manner, which also provides information to the user. For example, the characters and spacing of flat file 15 inform a user about tasks used in financial services projects. As flat file 15, users are not able to efficiently manage various tasks between different projects and processes.

Database management application (“DMA”) 19 represents any suitable software or logic that manages access to one or more databases. In the illustrated embodiment, DMA 19 interacts with framework application 18 to integrate flat files 15 into task database 30. In an embodiment, DMA 19 extracts flat files 15 from framework application 18 and manipulates the information for organization into activity database 30. To manipulate flat files 15, DMA 19 may execute various scripts. For example, DMA 19 may run Structured Query Language (SQL) scripts on the extracted flat files 15 to correct any errors in component business model names, such as misspellings or incomplete names. As another example, DMA 19 may run scripts on flat files 15 to create the structure that stores the data within task database 30. DMA 19 may also remove duplicate relationships or associations from flat files 15 or filter information from the extracted flat files 15 to facilitate storing the data in a form suitable for use by business units in enterprise 12. DMA 19 may also merge information from flat files 15 to create the data structure for inclusion in task database 30. The scripts run on flat files 15 may also extract pieces of information that are important for an associated process. In another embodiment, DMA 19 may also manipulate data structures from task database 30.

Management module 20 represents any suitable component that facilitates the integration of information from framework application 18 to task database 30 and facilitates the traceability and management of activities. Management module 20 may include a network server, any suitable remote server, a mainframe, a host computer, a workstation, a web server, a personal computer, a file server, or any other suitable device operable to communicate with computers 14 and process data. In some embodiments, management module 20 may execute any suitable operating system such as IBM's zSeries/Operating System (z/OS), MS-DOS, PC-DOS, MAC-OS, WINDOWS, a .NET environment, UNIX, OpenVMS, or any other appropriate operating system, including future operating systems. The functions of management module 20 may be performed by any suitable combination of one or more servers or other components at one or more locations. In the embodiment where the module is a server, the server may be a private server, and the server may be a virtual or physical server. For example, management module 20 may be local to enterprise 12 or remote to enterprise 12. Also, management module 20 may include any suitable component that functions as a server. In the illustrated embodiment, management module 20 includes an interface 24, a processor 26, a memory 28, task database 30, an input device 32, and an output device 34.

Interface 24 represents any suitable device operable to receive information from network 22 and/or computers 14, transmit information through network 22, perform processing of information, communicate to other devices, or any combination of the preceding. For example, interface 24 communicates information associated with a financial services project to computers 14. As another example, interface 24 receives information from computer 14a for inclusion in activity database 30. Interface 24 represents any port or connection, real or virtual, including any suitable hardware and/or software, including protocol conversion and data processing capabilities, to communicate through network 22 that allows management module 20 to exchange information with computers 14 or other components of system 10.

Processor 26 communicatively couples to interface 24, memory 28, task database 30, input 32 and output 34, and controls the operation and administration of management module 20 by processing information received from interface 24, memory 28, task database 30, input 32, and output 34. Processor 26 includes any hardware and/or software that operates to control and process information. For example, processor 26 executes software 36 to service computers 14 and manage applications 17. Processor 26 may be a programmable logic device, a microcontroller, a microprocessor, any suitable processing device, or any suitable combination of the preceding.

Memory 28 stores, either permanently or temporarily, data, operational software, or other information for processor 26. Memory 28 includes any one or a combination of volatile or non-volatile local or remote devices suitable for storing information. For example, memory 28 may include random access memory (RAM), read only memory (ROM), magnetic storage devices, optical storage devices, or any other suitable information storage device or a combination of these devices. While illustrated as including particular modules, memory 28 may include any suitable information for use in the operation of management module 20.

In the illustrated embodiment, memory 28 includes software 36 that facilitates the provision of service to computers 14 and the management of applications 18. Software 36 represents any suitable set of instructions, logic, or code embodied in a computer-readable storage medium. Memory 28 may also include applications 17 for use by computer 14 and/or activities associated with financial services projects.

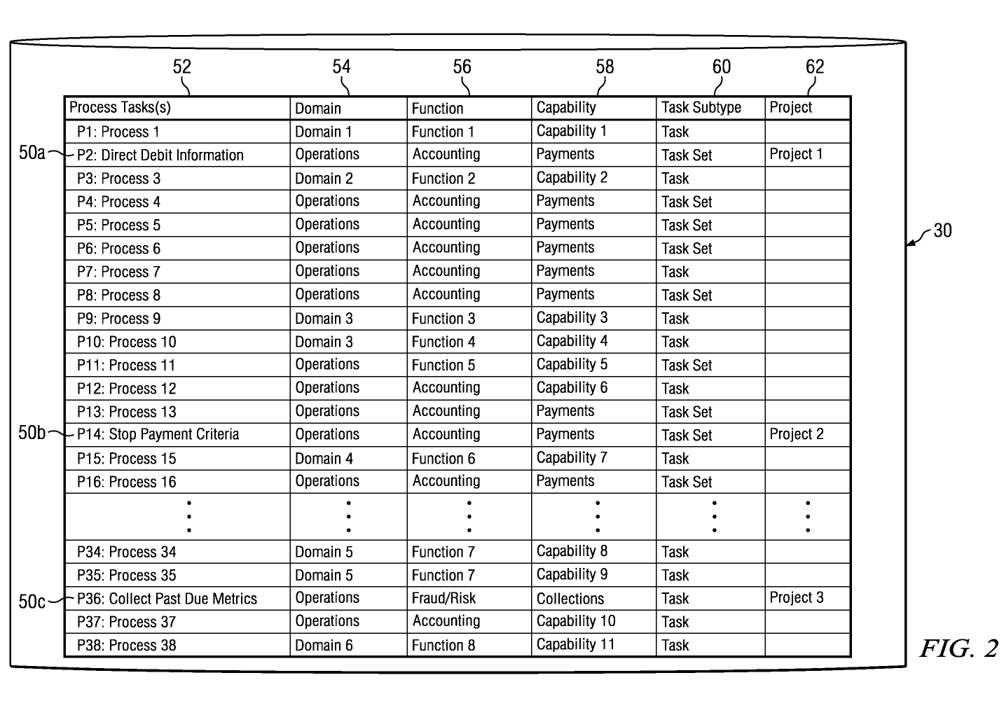

Task database 30 stores, either permanently or temporarily, data that facilitates modeling financial services processes. For example, task database 30 stores activities associated with various financial services projects. Because task database 30 centrally stores the activities, different business units may access the same information, which enhances collaborative development, reduces project risk, and increases the quality of applications and services before deployment. Task database 30 will be described in greater detail with respect to FIG. 2.

In some embodiments, input device 32 may refer to any suitable device operable to input, select, and/or manipulate various data and information. Input device 32 may include, for example, a keyboard, mouse, graphics tablet, joystick, light pen, microphone, scanner, or other suitable input device. Output device 34 may refer to any suitable device operable for displaying information to a user. Output device 34 may include, for example, a video display, a printer, a plotter, or other suitable output device.

Storage 21 stores, either permanently or temporarily, data, operational software, or other information for enterprise 12. Storage 21 includes any one or a combination of volatile or non-volatile local or remote devices suitable for storing information. For example, storage 21 may include random access memory (RAM), read only memory (ROM), magnetic storage devices, optical storage devices, or any other suitable information storage device or a combination of these devices. While illustrated as including particular modules, storage 21 may include any suitable information for use in the operation of enterprise 12 and modeling financial services projects. In the illustrated embodiment, storage 21 includes framework application 18, which, as described above, represents any suitable software or logic that enables a user to structure and scope business architecture domains and financial services projects using accelerated modeling.

Network 22 represents any suitable network operable to facilitate communication between the components of system 10 such as enterprise 12, computers 14, and management module 20. Network 22 may include any interconnecting system capable of transmitting audio, video, signals, data, messages, or any combination of the preceding. Network 22 may include all or a portion of a public switched telephone network (PSTN), a public or private data network, a local area network (LAN), a metropolitan area network (MAN), a wide area network (WAN), a local, regional, or global communication or computer network, such as the Internet, a wireline or wireless network, an enterprise intranet, or any other suitable communication link, including combinations thereof, operable to facilitate communication between the components.

In an exemplary embodiment of operation, computer 14a extracts flat file 15 from framework application 18. Flat file 15 is associated with an activity, and the activity may be associated with one or more financial services projects. DMA 19 executes scripts on flat file 15 to create a data structure for inclusion in activity database 30. For example, DMA 19 may execute a SQL script that manipulates flat file 15 to include a subtype field and a descriptions field in the data structure. As another example, DMA 19 executes SQL scripts to remove duplicate relationships, associations, and other information within the data structure. As yet another example, DMA 19 may run scripts on flat file 15 to determine whether any activities are missing that need to be included within the data structure and activity database 30. DMA 19 may also execute a SQL script to correlate capability names with the activity. Upon creating the data structure, computer 14a communicates with management module 20 to import the data structure into task database 30. The tasks are modeled into a process, which may be used to implement financial services projects.

Users of computers 14a-14n may access tasks stored in task database 30 to implement financial services projects. If it is determined that computer 14 desires to implement a project, computer 14 communicates with management module 20 to determine the tasks associated with the project. For example, computer 14b desires to open a deposit account. Computer 14b communicates with management module 20 to determine the tasks associated with opening the deposit account. Management module 20 determines the tasks associated with the project, accesses the tasks from task database 30, and communicates the tasks to computer 14b to facilitate opening the deposit account. Computer 14b may then open the deposit account according the tasks received from management module 20.

Modifications, additions, or omissions may be made to system 10 without departing from the scope of the invention. For example, computer 14 may extract flat files 15 from framework application 18 stored externally on storage 21 or framework application 18 internal to computer 14. Additionally, system 10 may include any number of computers 14, desktop modules 20, and networks 22. Any suitable logic may perform the functions of system 10 and the functions of components within system 10.

Any suitable component of system 10 may include an interface, logic, memory, and/or other suitable element. An interface receives input, sends output, processes the input and/or output and/or performs other suitable operations. An interface may comprise hardware and/or software. Logic performs the operation of the component, for example, logic executes instructions to generate output from input. Logic may include hardware, software, and/or other logic. Logic may be encoded in one or more non-transitory, tangible media, such as a computer-readable medium or any other suitable tangible medium, and may perform operations when executed by a computer. Certain logic, such as a processor, may manage the operation of a component. Examples of a processor include one or more computers, one or more microprocessors, one or more applications, and/or other logic.

FIG. 2 illustrates a particular embodiment of task database 30. In an embodiment, task database 30 represents RequisitePro®, which is a proprietary management tool from IBM® that facilitates management of requirements, improves traceability of financial services processes, promotes collaboration between business units in enterprise 12, and improves the quality of process modeling.

Task database 30 may be stored in management module 20 or may be stored in an external network storage device. Task database 30 stores a plurality of relational database data structures 50. Each data structure 50 is associated with a particular process task. Data structure 50 represents a hierarchy, from a high level to a low level, associated with each process task, feature, or function. The tasks may be used to model or implement a financial services process. Each task may have one or more attributes assigned to it to also facilitate modeling the financial services process. The attributes may include, but are not limited to, a project identification, a requirement for the task, a rule for the task, and a task within the financial services process. Data structure 50 may be stored in an organized manner within task database 30. In an embodiment, task database 30 is organized by an identifier assigned to each task. Each data structure 50 may have any suitable number of fields to represent the task. Each structure may also include any suitable number of fields associated with a process task.

In certain embodiments, data structure 50 may include the following fields: process task field 52, domain field 54, function field 56, capability field 58, task subtype field 60, and project field 62. Process task field 52 includes the process task used to model a process. In the illustrated embodiment, process task 52 includes an identifier and the name of the process task. Domain field 54 includes the line of business, business unit, or group associated with the process task. Function field 56 may include the broad function associated with the process task. Capability field 58 may include the specific business process associated with the process task. Task subtype field 60 includes the task type. In the illustrated embodiment, the task subtypes include task and task set. A task represents a single task to accomplish associated process task, and a task set represents multiple tasks to accomplish the process task. In an embodiment, each field is included for each data structure 50 in task database 30.

When interacting with task database 30, management module 20 may pull portions of each relevant data structure 50 to communicate to computer 14 to facilitate the process modeling. For example, management module 20 may extract and communicate the rules associated with a process task in data structure 50 rather than extracting and communicating the entire data structure 50.

In the illustrated embodiment, data structure 50a includes a “Direct Debit Information” process task, data structure 50b includes a “Stop Payment Criteria” process task, and data structure 50c includes a “Collect Past Due Metrics” process task. As mentioned above, each data structure 50 has different fields associated with the particular process task. The information in each field may vary depending on the type of process task. For example, in capability field 58, data structure 50a is related to payments, data structure 50b is also related to payments, and data structure 50c is related to collections. As another example, in task subtype field 58, data structure 50a is related to a task set, data structure 50b is related to a task set, and data structure 50c is related to a task.

Modifications, additions, or omissions may be made to task database 30. For example, task database 30 may include tasks from any suitable number of lines of business, business units, or groups and may be associated with any suitable number of functions or capabilities. As another example, any suitable component within system 10 may include task database 30.

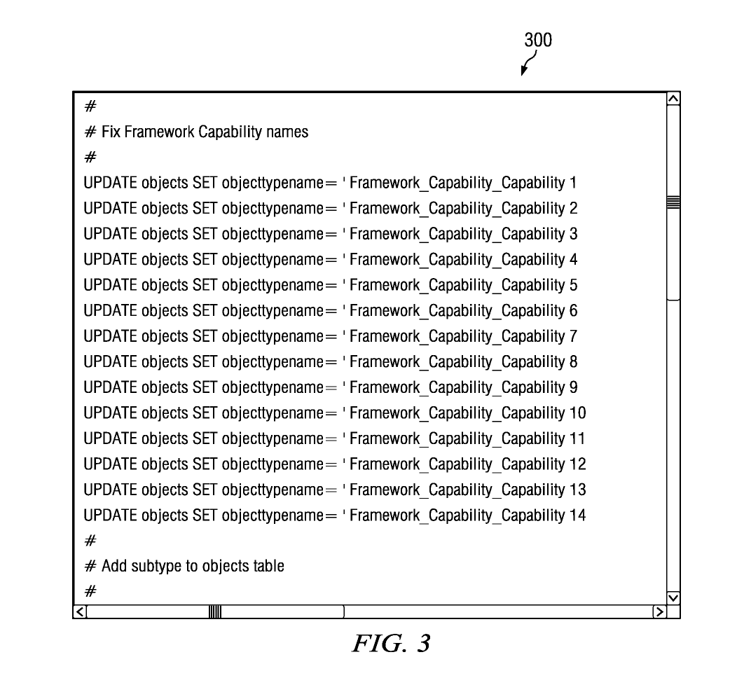

FIG. 3 illustrates an example screenshot 300 illustrating the manipulation of flat files 15 from framework application 18.

Screenshot 300 may be one embodiment of a user interface in which a user views the manipulation of flat files 15. In the illustrated screenshot, scripts are being run on flat files 15 to edit framework capability names. A list of names to be edited is shown on screenshot 300.

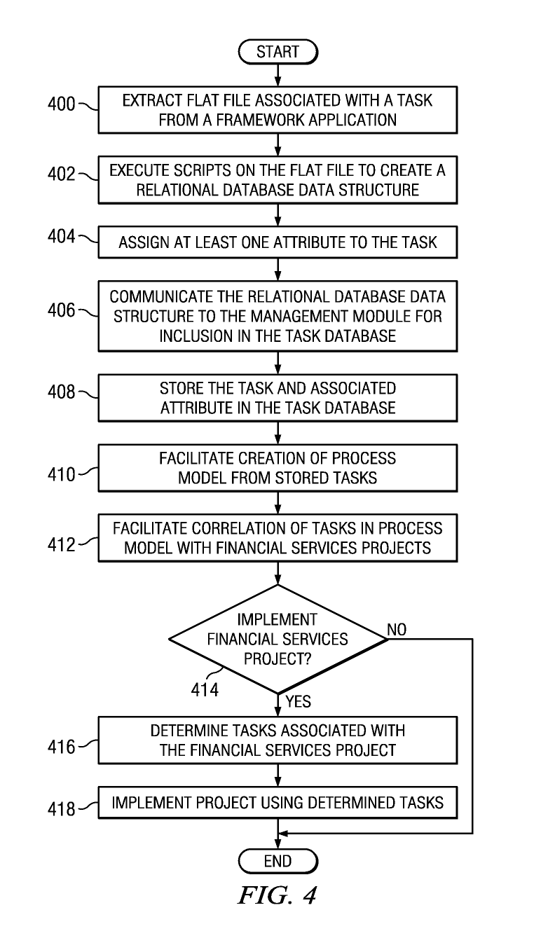

FIG. 4 illustrates a flowchart for integrating the information from framework application 18 to task database 30. The method begins at step 400 where computer 14a executes framework application 18 to extract a flat file 15 associated with an activity. Scripts are executed on flat file 15 at step 402 to create a relational database data structure 50. In an embodiment, computer 14a executes DMA 19 to run the scripts on flat file 15. When running the scripts on flat file 15, DMA 19 may manipulate the data in any suitable manner to create data structure 50. For example, DMA 19 may execute scripts to include a subtype field and a descriptions field in data structure 50. As another example, DMA 19 executes scripts to remove duplicate relationships, associations, and other information within data structure 50. As yet another example, DMA 19 may run scripts on flat file 15 to determine whether any tasks are missing that need to be included within data structure 50 and task database 30. DMA 19 may also execute a script to correlate capability names with the tasks.

At step 404, at least one attribute is assigned to the task included within data structure 50. These attributes may be used to link various tasks within task database 30. Example attributes include a project identification, a requirement for the task, a rule for the task, and a task within the financial services process. At step 406, computer 14a communicates data structure 50 to management module 20 for inclusion in task database 30, and management module 20 stores the task and the associated attribute in activity database 30 at step 408.

Computer 14 facilitates the creation of a process model from the stored tasks in step 410. The process model may include the tasks sequenced in a particular manner. The tasks in the process model are correlated with financial services projects at step 412. Computer 14 may facilitate this correlation. At step 414, computer 14 determines whether to implement a financial services project. If computer 14 determines to implement a project, the tasks associated with the particular financial services project are determined at step 416. In an embodiment, computer 14 communicates with management module 20 to determine the tasks. As an example, management module 20 may filter the data in activity database 30 to only identify tasks associated with a particular project. Upon receiving the tasks associated with the project, computer 14 implements the financial services project using the determined tasks at step 418. Computer 14 may continue to extract flat files 15, model processes using the tasks, and/or implement projects before the method terminates. If computer 14 determines not to implement a project at step 414, the method may subsequently terminate.

Modifications, additions, or omissions may be made to the flowchart. For example, computer 14 may use the determined tasks for modeling purposes only instead of implementation of the financial service process. Additionally, steps in FIG. 4 may be performed in parallel or in any suitable order.

Certain embodiments of the invention may provide one or more technical advantages. A technical advantage of one embodiment includes integrating a framework application and a task database through an automated method to consolidate tasks associated with the various financial services processes. This integration provides intelligent identification of specific tasks associated with a process, rather than having to manually determine the tasks associated with a process and subsequently manually applying the tasks to implement the process. Another technical advantage of the integration facilitates modeled processes to be reused across different business units within the enterprise, which reduces costs and improves efficiency.

Although the present invention has been described with several embodiments, a myriad of changes, variations, alterations, transformations, and modifications may be suggested to one skilled in the art, and it is intended that the present invention encompass such changes, variations, alterations, transformations, and modifications as fall within the scope of the appended claims.

What is claimed is:

1. A method for integrating a framework application and a task database associated with a financial services enterprise, comprising:
extracting a flat file from a framework application, wherein the flat file is associated with a task and the task is associated with a financial services project;
manipulating, by a processor, the flat file to form a relational database data structure associated with the task; and
communicating the relational database data structure to a management module, wherein the management module stores the relational database data structure in the task database to facilitate modeling the financial services project associated with a financial services enterprise.

2. The method of claim 1, wherein manipulating the flat file to form a relational database data structure comprises executing one or more scripts to manipulate the flat file to form a relational database data structure.

3. The method of claim 1, further comprising extracting information from the relational database data structure stored in the task database to model the financial services project associated with the financial services enterprise.

4. The method of claim 1, further comprising assigning at least one attribute to the task in the task database, wherein the attributes facilitate modeling a financial services process associated with the financial services project.

5. The method of claim 4, wherein the attribute comprises at least one of the following:
a project identification;
a requirement for the task;
a rule for the task; and
a task within the financial services process.

6. The method of claim 1, further comprising:
determining a first financial services project associated with the financial services enterprise to implement;
determining a plurality of tasks associated with the first financial services project; and
implementing the first financial services project according to the determined plurality of tasks.

7. The method of claim 1, wherein manipulating the flat file to form a relational database data structure comprises:
including an activity subtype in the relational database data structure; and
including an activity description in the relational database data structure.

8. A non-transitory computer readable medium comprising logic for integrating a framework application and a task database associated with a financial services enterprise, the logic, when executed by a processor, operable to:
extract a flat file from a framework application, wherein the flat file is associated with a task and the task is associated with a financial services project;
manipulate the flat file to form a relational database data structure associated with the task; and
communicate the relational database data structure to a management module, wherein the management module stores the relational database data structure in the task database to facilitate modeling the financial services project associated with a financial services enterprise.

9. The medium of claim 8, wherein manipulating the flat file to form a relational database data structure comprises executing one or more scripts to manipulate the flat file to form a relational database data structure.

10. The medium of claim 8, the logic further operable to extract information from the relational database data structure stored in the task database to model the financial services project associated with the financial services enterprise.

11. The medium of claim 8, the logic further operable to assign at least one attribute to the task in the task database, wherein the attributes facilitate modeling a financial services process associated with the financial services project.

12. The medium of claim 11, wherein the attribute comprises at least one of the following:
a project identification;
a requirement for the task;
a rule for the task; and
a task within the financial services process.

13. The medium of claim 8, the logic further operable to:
determine a first financial services project associated with the financial services enterprise to implement;
determine a plurality of tasks associated with the first financial services project; and
implement the first financial services project according to the determined plurality of tasks.

14. The medium of claim 8, wherein manipulating the flat file to form a relational database data structure comprises:
including an activity subtype in the relational database data structure; and
including an activity description in the relational database data structure.

15. A system for integrating a framework application and a task database associated with a financial services enterprise, comprising:
a processor operable to:
extract a flat file from a framework application, wherein the flat file is associated with a task and the task is associated with a financial services project; and
manipulate the flat file to form a relational database data structure associated with the task; and
an interface operable to communicate the relational database data structure to a management module, wherein the management module stores the relational database data structure in the task database to facilitate modeling the financial services project associated with a financial services enterprise.

16. The system of claim 15, wherein the processor is further operable to execute one or more scripts to manipulate the flat file to form a relational database data structure.

17. The system of claim 15, wherein the processor is further operable to extract information from the relational database data structure stored in the task database to model the financial services project associated with the financial services enterprise.

18. The system of claim 15, wherein the processor is further operable to assign at least one attribute to the task in the task database, wherein the attributes facilitate modeling a financial services process associated with the financial services project.

19. The system of claim 18, wherein the attribute comprises at least one of the following:
a project identification;
a requirement for the task;
a rule for the task; and
a task within the financial services process.

20. The system of claim 15, wherein the processor is further operable to:
determine a first financial services project associated with the financial services enterprise to implement;
determine a plurality of tasks associated with the first financial services project; and
implement the first financial services project according to the determined plurality of tasks.
